(19) United States
(12) Patent Application Publication
(10) Pub. No.: US 2006/0135373 A1
(43) Pub. Date: Jun. 22, 2006

(54) Apparatus for purifying waste lubricant and method of purifying waste lubricant using the same

(76) Inventors: Sang Hyun Jeong, Daejeon (KR); Seong Je Park, Daejeon (KR); Won Seok Hong, Daejon (KR); Yong Jin Kim, Daejeon (KR); Kyung Hoe Koo, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 10/545,703

(22) PCT Filed: Apr. 17, 2004
(86) PCT No.: PCT/KR04/00889

§ 371 Date: Aug. 17, 2005

(30) Foreign Application Priority Data
Apr. 21, 2003 (KR) 10-2003-0025066

(51) Int. Cl. C10M 175/00; B01J 10/00

(52) U.S. Cl. 508/111; 422/188

(57) ABSTRACT

There are provided an apparatus and a method for eliminating water and particulate pollutant contained in a waste lubricant. The waste lubricant heated up to a proper temperature is injected into a vacuum chamber through a nozzle, the vacuum chamber maintaining a predetermined degree of vacuum. The water contained in the waste lubricant is vaporized according to a relationship between a vaporizing temperature of the waste lubricant and a vaporizing temperature of the water contained in the waste lubricant. The vaporized water is transformed into condensate water while passing through a condenser, and is stored in a water storage container. In addition, the waste lubricant, from which water is eliminated, is introduced into a waste lubricant discharging chamber by discharging means, and is passed through an electrostatic separator by an oil pump, to collect particulate pollutant. Two electrodes, each having a polarity opposite to each other, are provided inside the electrostatic separator, and are applied with a high voltage by a high-voltage generating unit, so as to form a strong electric field in a space between the two electrodes, in which the waste lubricant is located, and collect particulate pollutant contained in the waste lubricant by the electrostatic force in the electric field.

### TECHNICAL FIELD

The present invention relates to an apparatus and a method for eliminating water and particulate pollutant contained in a waste lubricant or waste operating oil which is classified as industrial discharge waste by domestic regulations, and more particularly, to an apparatus and a method for purifying a waste lubricant by eliminating water and particulate pollutant from the waste lubricant being enough to be used by recycling, and making a lubricant being used for a long time by purifying the lubricant during an operation and suppressing the generation of waste lubricant, thereby preventing environment pollution and cleaning discharged waste lubricant for recycling.

### BACKGROUND ART

In general, lubricant used in various machine tools, hydraulic tools, automobile combustion engines, industries, or the like is mixed with water and particulate pollutant, thereby causing the tools malfunctioning and deterioration.

The water contained in the lubricant is a pollutant most generally produced in lubricant system, and has various influences on corrosion of the tool, reduction of lubricant characteristics, fluid damages, trapping of additive, reduction of dielectric strength, wear of hydraulic product, oxidation of lubricant, or the like.

In addition, the particulate pollutant contained in the lubricant causes wear of the machine to increase due to friction between an inner surface of the machine and the particulates, and causes frictional force, temperature and pressure of a lubricant portion to increase due to the rupture of an oil film formed on the inner surface of the machine, thereby leading to the significant rupture of the machine.

In order to prolong a lifetime of the machine and maintain the operation at a normal state, the lubricant nust be periodically replaced with new one according to a degree of pollution. A lot of waste lubricant resulted from the replacement becomes a chief reason of environment pollution.

Various conventional techniques for recycling the waste lubricant have been proposed depending upon a kind of lubricant and a recycling purpose. Since a method generally used employs a simple technique of centrifugal purification, filtering, chemical treat or the like, the recycled lubricant is used as not lubricant again, but a fuel oil in most cases.

A conventional waste lubricant purifying apparatus is mainly focused on a technique of eliminating the particulate pollutant, and the employed techniques generally utilize a centrifugal purification or cartridge-type oil filter. In the case of the centrifugal purification, a processing capability thereof is high, but an eliminating capability is very low.

In particular, in the case of the cartridge-type oil filter having a good eliminating capability to some extent, there are some problems, such as increased pressure of system due to clogging of the filter, increased cost of maintenance due to the periodic replacement of the filter, and production of secondary pollutant of waste lubricant filter. In particular, in the case of high viscosity lubricant, it is impossible to use the technique by the increased pressure due to the clogging of the filter.

As the latest technique of removing the water contained in the waste lubricant, a method of decompressing the waste lubricant and heating/injecting the same is employed. A simple decompression/vaporization is generally utilized, without considering a type of injection nozzle according to decompressed condition, the running stability of an apparatus and the continuous treatment. Since a running characteristic of the apparatus, a processing capability per hour, a capability every kind of waste lubricant are so varied, there is a problem of significantly reduced capability of the purification of the waste lubricant.

The techniques described above are applied unitarily or complexly to purify the waste lubricant, but it is not possible to eliminate the particulate pollutant below about 5 microns. In addition, it is difficult to eliminate fluid pollutants, such as water, resin substances, oxides or the like. In particular, it is not easy to completely eliminate the dissolved water or fine particles below 1 micron.

### DISCLOSURE OF INVENTION

### Technical Problem

Therefore, an object of the present invention is to solve the problems involved in the prior art, and to provide a waste lubricant purifying apparatus capable of simultaneously eliminating or trapping water and particulate pollutant from waste lubricant in succession.

The present invention may include an apparatus for simultaneously eliminating the water and the particulate pollutant from the waste lubricant, or an apparatus for separately eliminating the water and the particulate pollutant from the waste lubricant by disassembling components of the apparatus.

According to the elimination of the water from the waste lubricant, the waste lubricant heated by a proper temperature is injected into a vacuum chamber through a nozzle by vacuum pressure. The water contained in the waste lubricant is vaporized according to a relationship between saturation vapor pressure and temperature of the water contained in the waste lubricant and the waste lubricant. The vaporized water is transformed into condensate water by condensation.

According to the elimination of the particulate from the waste lubricant, the waste lubricant flows into an electrostatic separator, and the flow of the waste lubricant is uniformly distributed by a honeycomb. The uniform flow of the waste lubricant is passed through a discharging unit consisting of a discharge electrode and a ground electrode. The discharge electrode is applied with a high voltage, and the ground electrode is spaced apart form the discharge electrode. If the discharge electrode is applied with the high voltage, corona discharge is generated between the discharge electrode and the ground electrode. The particulate pollutant contained in the waste lubricant is electrically charged by a lot of charges generated by the coronal discharge.

The charged particulate pollutant flows in the electrostatic trapping unit. When the waste lubricant passes through many pair of electrodes each applied with a high voltage of opposite polarity to form a strong electric field formed between the electrodes having an opposite polarity to each other, the particulate pollutant contained in the waste lubricant is charged by the electric field. The discharged particulate pollutant is adhered to a trapping filter adjacent to the electrode having a polarity opposite to that of the discharged particulate pollutant.

A technical principle of the waste lubricant eliminating apparatus and the method thereof will now be described.

According to a principle of eliminating the water from the waste lubricant, in the case that a tube connected to a waste lubricant container is installed in a vacuum chamber maintained in a vacuum state by a vacuum pump, and an injection nozzle is installed to one end of the tube, the waste lubricant is injected into the vacuum chamber through the nozzle by the vacuum pressure. At this time, a temperature of the saturation vapor pressure of the water contained in the injected waste lubricant is lowered to a temperature of a saturation vapor corresponding to the vacuum pressure in the vacuum chamber, and the water contained in the waste lubricant is vaporized even in a lower temperature.

At this time, since an internal pressure of the vacuum chamber and a temperature of the waste lubricant are not proper to vaporize the lubricant, only the water contained in the waste lubricant can be vaporized and eliminated.

A below Table 1 represents a saturation vapor pressure of the water in each degree of vacuum. As shown in Table 1, it would be appreciated that the higher the degree of vacuum is, the more easily evaporation occurs at a lower temperature. This means that the water start to vaporize when the supplied waste lubricant is at a temperature equal to or above 50° C., in the case that a degree of vacuum is 93 torr.

TABLE 1
degree of vacuum and temperature of saturation vapor pressure

| | Temperature of Saturation |
|---|---|
| Degree of Vacuum (torr) | Vapor Pressure (° C.) |
| 760 | 100 |
| 93 | 50 |
| 4.8 | 50 |
| 0.1 | −40 |

According to the present invention, the waste lubricant flowing in to the vacuum chamber is heated to an optimum temperature proper to vaporize the water contained in the waste lubricant in a vacuum decompressed state by the heating unit, and then, is injected by the injection nozzle. Therefore, a surface area of the injected oil is increased to optimize a vaporizing efficiency of the water. The vaporized water is discharged from the vacuum chamber by the vacuum pump, and is condensed while passing through the condenser. The condensate water is stored in the condensate container to be discharged to the exterior.

Also, the waste lubricant, from which the water is eliminated by the water eliminating unit, flows into the electrostatic separator, which is a trapping unit for particulate pollutant, by the oil pump. If the discharge electrode is applied with a high voltage to generate the corona discharge, the particulate pollutant passes through a space between many pairs of electrodes, each facing electrode applied with opposite polarity, to form a strong electric field. The particulate pollutant charged by the discharge electrode is adhered by the electric field to a trapping filter of an adjacent electrode, thereby eliminating the particulate pollutant from the waste lubricant.

With the above description, since the water and the particulate pollutant are simultaneously eliminated, the purified lubricant has a high grade of quality, and can be recycled as a new lubricant.

### DESCRIPTION OF DRAWINGS

The above objects, other features and advantages of the present invention will become more apparent by describing the preferred embodiment thereof with reference to the accompanying drawings, in which:

FIG. 1 is a view to illustrate constructions of a waste lubricant purifying apparatus and an entire system employing the apparatus according to one embodiment of the present invention.

FIG. 2 is an enlarged cross-sectional view to illustrate a main part of a unit for eliminating water contained in waste lubricant according to one embodiment of the present invention.

FIG. 3 is a perspective view of an injection nozzle according to the present invention.

FIG. 4 is a detailed view to illustrate one example of a corona discharging unit and an electrical trapping unit installed to an electrostatic separator to trap a particulate pollutant according to the present invention.

FIG. 5 is a view to illustrate one example of a coating around an electrode of an electrical trapping unit according to the present invention.

### MODE FOR INVENTION

Reference will now be made in detail to preferred embodiments of the present invention, examples of which are illustrated in the accompanying drawings.

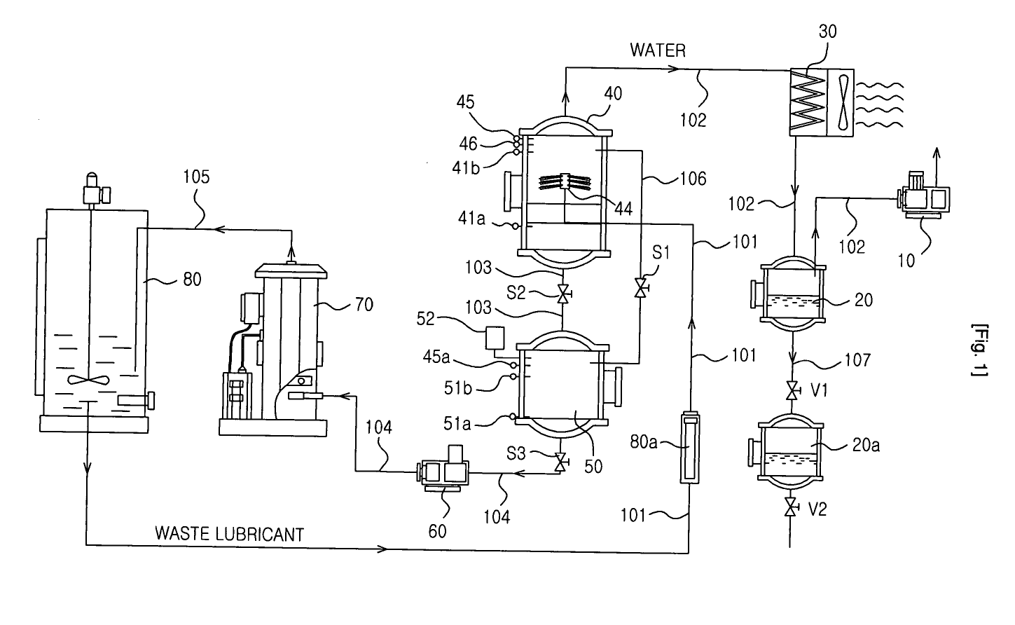

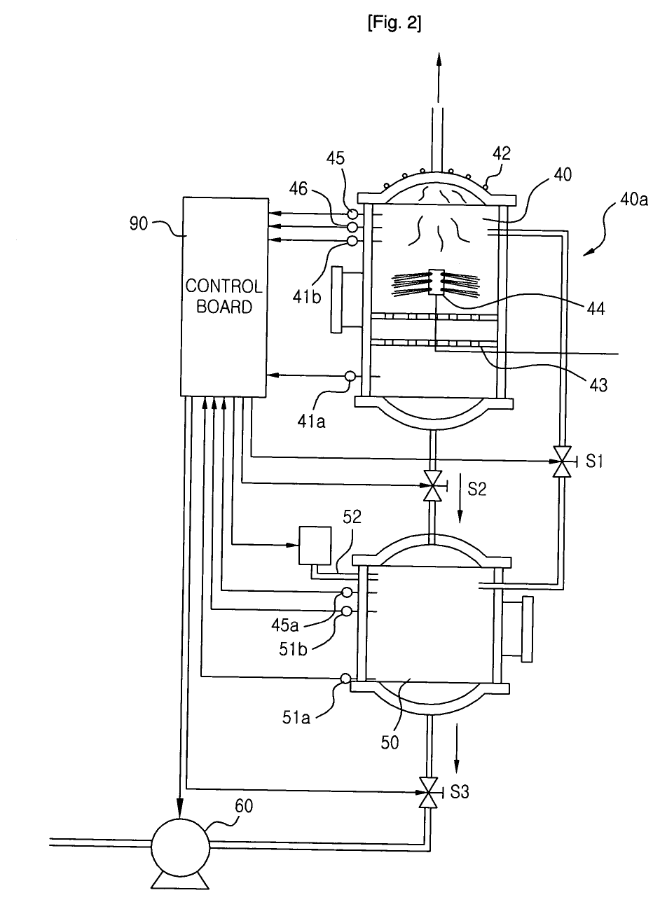

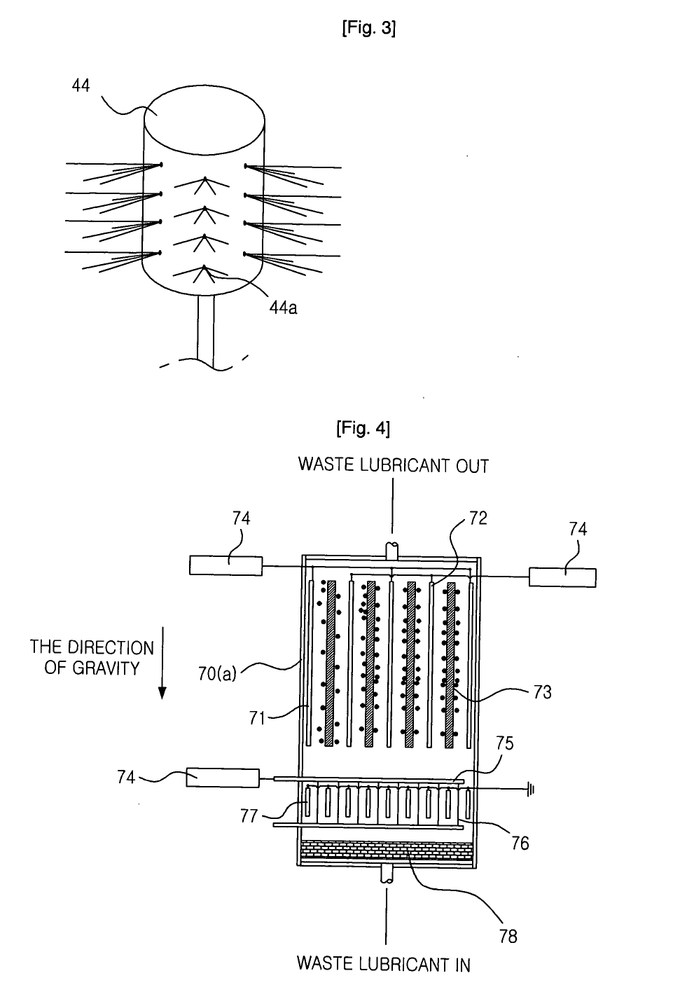

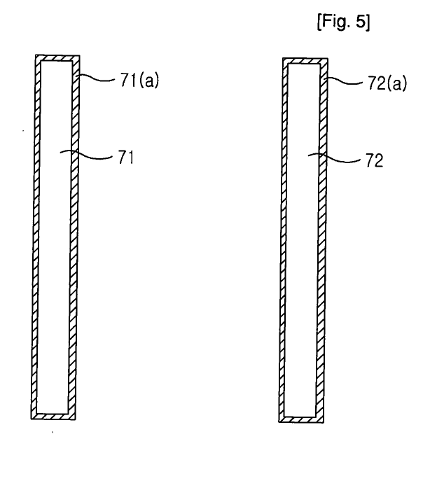

FIG. 1 is a view to illustrate a construction of an entire system employing a waste lubricant purifying apparatus for eliminating both water and particulate pollutant contained in waste lubricant according to a preferred embodiment of the present invention. FIG. 2 is an enlarged cross-sectional view to illustrate a main part of a unit for eliminating water contained in the waste lubricant according to a preferred embodiment of the present invention. FIG. 3 is an enlarged perspective view of an injection nozzle according to the present invention. FIG. 4 is a detailed view of a corona discharging unit and an electrical trapping unit installed to an electrostatic separator to trap a particulate pollutant according to the present invention. FIG. 5 is a view illustrating a coating around an electrode of an electrical trapping unit.

The construction of the present invention will now be described in reference to FIGS. 1 to 4.

A waste-lubricant storing container 80, a heater 80a and a vaporizing chamber 40 are connected to each other via a supply tube 101. The supply tube 101 is extended to an interior of the vaporizing chamber 40, and has an injection nozzle 44 at one end thereof. A vacuum pump 10, a condensate water container 20, an auxiliary condensate water container 20a, a condenser 30 and the vaporizing chamber 40 are connected to each other via a condensing tube 102. Also, the vaporizing chamber 40, a discharging chamber 50, an oil pump 60 and an electrostatic separator 70 for eliminating a particular pollutant are connected to each other via a carrying tube 104. A solenoid valve S2 is installed to a discharging tube 103 between the vaporizing chamber 40 and the discharging chamber 50. A solenoid valve S3 is installed to the carrying tube 104 between the discharging chamber 50 and the oil pump 60. A solenoid valve S1 is installed to a pressure adjusting tube 106 between the vaporizing chamber 40 and the discharging chamber 50.

An operation of the apparatus shown in FIGS. 1 to 4 will now be described.

In the state that the solenoid valve S1 is opened, while the solenoid valve S2, the solenoid valve S3 and a valve V1 are closed, when the vacuum pump 10 is operated, an internal pressure of the vaporizing chamber 40, the condenser 30, the condensate water container 20 and the discharging chamber 50, which are connected to each other via the condensing tube 102, is lowered to generate a vacuum pressure therein. The waste lubricant stored in the oil storing container 80 is carried to the supply tube 101 by the vacuum pressure generated in the vaporizing chamber 40, and thus is injected into the interior of the vaporizing chamber 40 through the injection nozzle 44 installed to the end of the supply tube 101. At this time, the waste lubricant injected into the interior of the vaporizing chamber 40, while flows through a heating unit 80a installed to the supply tube 101, is injected as a heated waste lubricant. When the waste lubricant is injected into the vaporizing chamber 40 through the nozzle 44, the water contained in the waste lubricant can be vaporized by adjusting its temperature at a saturation vapor temperature of water vapor corresponding to the vacuum pressure in the vaporizing chamber 40. The vaporized water flows into the condenser 30 through the condensing tube 102 by the vacuum pressure generated by the vacuum pump 10. Then, the water is condensed while passing through the condenser 30, and is stored in the condensate water container 20. An entire water vaporizer associated with the above description can be indicated by a reference numeral 40a, which has not been mentioned.

After the condensate water stored in the condensate water container 20 is carried to an auxiliary condensate water container 20a installed to a lower end of the condensate water container 20 by the opening of a valve V1 provided to a condensate water discharging tube 107, the valve V1 is closed, and a valve V2 is opened, to discharge the condensate water outwardly. If the waster lubricant injected into the vaporizing chamber 40 reaches to a predetermined amount, the waste lubricant flows into the discharging chamber 50 by the operation of discharging means. Also, if the waste lubricant carried into the discharging chamber 50 is increased up to a level above a predetermined amount, the waste lubricant, from which the water is removed, is carried into the electrostatic separator 70 by the discharging means.

One preferred embodiment of the discharging means will now be described.

The discharging means includes a pair of upper and lower position sensors 41a and 41b; 51a and 51b spaced apart from each other at upper and lower portions of the vaporizing chamber 40 and the discharging chamber 50, respectively, for detecting a level of the waste lubricant in the vaporizing chamber 40 and the discharging chamber 50, and a control board 90 with a program embedded for receiving a signal detected by the respective upper and lower position sensors 41a and 41b; 51a and 51b and thus selectively opening/closing the solenoid valves S1, S2 and S3.

According to the discharging means, the upper position sensor 41b and the lower position sensor 41a are installed at upper and lower positions of the vaporizing chamber 40, respectively, such that the waste lubricant injected into the vaporizing chamber 40 has a constant volume. If the level of the waste lubricant filled in the vaporizing chamber 40 reaches the upper position sensor 41b, the control board 90 receives a signal from the upper position sensor 41b, which is connected to the control board 90, and sends a signal for opening the solenoid valve S2 installed in the discharging tube 103 between the vaporizing chamber 40 and the discharging chamber 50, so as to open the solenoid valve S2.

The waste lubricant stored in the vaporizing chamber 40 flows to the discharging container 50 through the discharging tube 103. At this time, the solenoid valve S3 installed in the carrying tube 104 positioned at the lower portion of the discharging container 50 is closed. The upper position sensor 51b and the lower position sensor 51a are installed at upper and lower positions of the discharging chamber 50, respectively, such that the waste lubricant carried into the discharging chamber 50 has a constant volume. If the level of the waste lubricant filled in the discharging chamber 50 reaches to the upper position sensor 41b, the control board 90 receives a signal from the upper position sensor 51b, which is connected to the control board 90, and sends a signal for closing the solenoid valve S2 installed in the discharging tube 103 between the vaporizing chamber 40 and the discharging chamber 50, and the solenoid valve S1 installed in the pressure adjusting tube, so as to close the solenoid valve S2 and the solenoid valve S1. Simultaneously, the control boards 90 sends command signals for purging the vacuum in the discharging chamber 50 by opening an air duct 52 installed in the discharging chamber 50, opening the solenoid valve S3 and operating the oil pump 60 so that the waste lubricant stored in the discharging chamber 50 is carried to the electrostatic separator 70 to eliminate the particulate pollutant.

At this time, since the vaporizing chamber 40 is maintained without a change of a degree of vacuum thereinside, the waste lubricant is continuously injected through the nozzle 44.

Further, since the discharging chamber 50 is maintained in light vacuum even with vacuum slightly reduced, the oil pump 60, which is to discharge the waste lubricant from the discharging chamber 50, operates when the discharging chamber 50 is maintained with a predetermined degree of vacuum applied thereon.

If the waste lubricant is discharged from the discharging chamber 50 by the oil pump 60, and thus the level of the waste lubricant reaches the lower position sensor 51a, the control board receives a signal from the lower position sensor 51, which is connected to the control board, to close the air duct 52 and the solenoid valve S3, stop the operation of the oil pump 60, and open the solenoid valve S1 of the pressure adjusting tube.

After the waste lubricant is discharged and the air duct 52 and the solenoid valve S3 are closed, a degree of vacuum in the interior of the discharging chamber 50 is to be equal to that of the vaporizing chamber 40 connected to the discharging chamber 50 via the pressure adjusting tube 106. By the vacuum pump 10, the vacuum inside the vaporizing chamber 40 and the discharging chamber 50 is returned to an original degree, so that the nozzle is maintained in a state of injecting the waste lubricant. Accordingly, the above process is continuously repeated to eliminate the water from the waste lubricant.

FIG. 2 is a detailed view to illustrate a main part of the water eliminating unit, and the process thereof.

A heating unit 42 having a built-in heating wire is installed at an upper end of the vaporizing chamber 40 for heating a cover of the vaporizing chamber 40. The hating unit is to prevent vapor contacted to an inner wall and the cover of the vaporizing chamber 40 from being condensed due to a temperature difference between an inside and an outside of the vaporizing chamber 40, when the water vaporized in the vaporizing chamber 40 is discharged from the vaporizing chamber 40 via the tube 102.

Accordingly, the water vaporized in the vaporizing chamber 40 is discharged by the vacuum pressure, and is condensed while passing through the condenser 30. The condensed water is collected into the condensate water container 20 and then is discharged outward.

Also, a porous plate 43 is installed in the vaporizing chamber 40 to increase a dwelling time of the waste lubricant injected by the injection nozzle 44 in a vaporizing space formed in the vaporizing chamber 40.

FIG. 3 shows the injection nozzle 44 adapted to finely inject the waste lubricant. As shown in FIG. 3, the cylindrical-shaped injection nozzle 44 has a plurality of fine injection holes 44a perforated in a cylindrical outer wall of the nozzle. The fine injection holes 44a are to maximize a surface area of the injected waste lubricant, thereby increasing a vaporizing efficiency of the water.

In addition, the waste lubricant is carried to the electrostatic separator 70 by the oil pump 60, and the particulate pollutant contained in the waste lubricant is eliminated by an electrostatic screening operation. The detailed construction of the electrostatic separator 70 according to the present invention is as follows.

The electrostatic separator 70 includes, as shown in FIG. 4, a honeycomb 78 for uniformly distributing the flow of the waste lubricant, a corona discharging unit having a discharge electrode 76 connected to a discharge electrode frame 75 and a ground electrode 77, an electrode 71 applied with positive (negative) high voltage, an electrode 72 spaced apart from the electrode 71 at a constant interval and applied with a high voltage having a polarity opposite to that of the electrode 71 or grounded, a high-voltage generating unit 74 for applying high voltage to the electrodes 71, 72, and the discharge electrode 76, and a casing 70a.

Also, the electrostatic separator 70 includes a trapping filter 73 displaced between the electrodes 71 and 72 having the opposite polarity, with the filter being parallel with surfaces of the electrodes 71 and 72, such that the pollutant is directly adhered to the filter. The electrodes are provided with protection coatings 71a and 72a to protect the surfaces thereof.

A process of eliminating the pollutant contained in the waste lubricant using the electrostatic separator described above will now be described.

The waste lubricant, which is introduced into the electrostatic separator 70 by the oil pump, forms a uniform flow while passing through the honeycomb 78. The uniform flow of the waste lubricant is passed through the corona discharging unit. At this time, if the discharge electrode frame 75 is applied with a high voltage from the high-voltage generating unit 74, a lot of charges are generated between the discharge electrode 76 and the ground electrode 77 by the corona discharge. The particulate pollutant contained in the waste lubricant is electrically charged by the charges.

The charged particulate pollutant flows into the electrostatic trapping unit. When the waste lubricant passes through the electrodes 71 and 72 each applied with a high voltage of opposite polarity, by which a strong electric field is formed between the electrodes, the particulate pollutant contained in the waste lubricant is moved toward the electrodes by the electric field.

Thus, the pollutant moved by the electric field is trapped on a surface of the trapping filter 73 installed between the electrodes, and the lubricant with the pollutant eliminated is carried to the oil storing container 80.

In order to prevent the generation of spark on the surfaces of the electrodes 71 and 72 and the unbalance of the electric field, the surfaces of the electrodes are provided with the coatings 71a and 72a, thereby maximizing an efficiency of eliminating the particular pollutant by forming a uniform electric field during a long time of operation.

The electrostatic separator 70 shown in FIG. 4 according to the present invention is similar to a conventional electrostatic precipitation, except that most of pollutant is trapped by the trapping filter 73 installed between the electrodes to minimize an effect exerted on the electrodes due to a concentration of the pollutant. In addition, since the displaced direction of the trapping filter 73 is parallel with the surfaces of the electrodes 71 and 72, the present invention can significantly reduce a pressure loss relative to a conventional method employing an oil filter. Therefore, the pressure load is not applied to the oil pump 60 of the water eliminating apparatus, thereby eliminating the particulate pollutant at high performance.

The particulate pollutant adhered to the filter does not exert an influence on the flow of the waste lubricant for long operation, so that a replacing cycle of the filter is remarkably prolonged to reduce an operation cost.

The waste lubricant with the particulate pollutant eliminated by the electrostatic separator 70 flows again to the oil storing container 80 to repeat the above processes of removing the water and eliminating the particular pollutant, thereby perfectly purifying the waste lubricant at a high degree of cleanness.

A process of purifying the waste lubricant by removing the water and the particular pollutant from the waste lubricant includes the following steps of:

1) operating the vacuum pump 10 such that a vacuum pressure is transferred to the condensate water container 20, the condenser 30, and the vaporizing chamber 40 so as to decompress the interior of the vaporizing chamber 40 in a vacuum state;

2) injecting a heated waste lubricant into the interior of the vaporizing chamber 40 by the injection nozzle 44 installed inside the vaporizing chamber 40 using the vacuum pressure, vaporizing the injected waste lubricant using a vacuum vaporizing temperature, condensing the vaporized water by passing through the condenser 30, collecting the condensed water in the condensate water container 20, and discharging the collected water from the auxiliary condensate water container 20a to an exterior;

3) discharging the waste lubricant into the discharging chamber 50 when a predetermined amount of the waste lubricant is stored in the vaporizing chamber 40, and discharging the waste lubricant using the discharging means when a predetermined amount of the waste lubricant is stored in the discharging chamber 50;

4) applying a high voltage to the discharge electrode frame 75 from the high-voltage generating unit 74 consisting of the discharge electrode 76 and the ground electrode 77 to eliminate the particular pollutant contained in the waste pollutant carried by the oil pump 10, electrically charging the particular pollutant using a lot of charges produced by the corona discharge generated between the discharge electrode 76 and the ground electrode 77, and trapping the particulate pollutant by the trapping filter 73 using the electrostatic force in the electric field formed between the electrodes 71 and 72 each provided with the coatings 71a and 72a and applied with a high voltage of opposite polarity; and

5) collecting the waste lubricant with foreign substance eliminated therefrom into the oil storing container 80.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As apparent from the above description, according to the present invention, one system can continuously perform the process of removing the water and eliminating the particulate pollutant from the waste lubricant.

It is possible to purify and reuse an oil for a precision hydraulic apparatus, such as bearing oil, hydraulic operating oil, cutting oil and the like, required for a high degree of cleanness among an expensive fuel oil or lubricant. In particular, the apparatus of the present invention can be directly connected to equipment associated with a process, and can be applied to a lubricant of all the processes.

In addition, the present invention has effects of purifying the existent waste lubricant, as well as suppressing the generation of the waste lubricant. Therefore, it is very useful in the aspects of environment pollution control and waste recycling.

1. An apparatus for purifying a waste lubricant, by which water and particulate pollutant are eliminated from the waste lubricant, the apparatus comprising:
an oil storing container for storing the waste lubricant;
a vaporizing chamber connected to a condensate water container and a condenser and vacuumized at inner pressure thereinside by a vacuum pump;
a heating unit for heating the waste lubricant discharged from the oil storing container;
an injection nozzle installed in the vaporizing chamber and connected to an outlet of the heating unit for injecting the heated waste pollutant by internal vacuum pressure;
discharging means for controlling discharge and storage of the waste lubricant in the vaporizing chamber by using a position sensor, detecting a level of the waste lubricant in a discharging chamber, which temporally stores the waste lubricant, and discharging the waste lubricant from the discharging chamber while the waste lubricant is injected from the injection nozzle;
an oil pump operating for discharging oil from the discharging chamber using the discharging means;
an electrostatic separator on a path through which the oil pumped by the oil pump flows, to electrically charge particulate pollutant, and having an electrode and a trapping filter for trapping the charged particulate pollutant;
a high-voltage generating unit for applying high voltage to the electrode; and
an oil container for collecting the waste lubricant from which the particulate pollutant is eliminated by the electrostatic separator.

2. The apparatus for purifying the waste lubricant as claimed in claim 1, wherein the discharging means comprises a pair of upper and lower position sensors spaced apart from each other at upper and lower portions of the vaporizing chamber and the discharging chamber respectively, and a control board for receiving a signal detected by the respective position sensors and selectively opening/closing solenoid valves,
in which the solenoid valves are opened to open a discharging tube and a pressure adjusting tube, which are connected between the vaporizing chamber and the discharging chamber, thereby discharging the oil from the vaporizing chamber to the discharging chamber,
in which if the discharging chamber is filled with a predetermined amount of the oil, the control board controls to close the solenoid valve of the discharging tube and the pressure adjusting tube, according to a signal detected by the position sensor,
in which the solenoid valve of a carrying tube is opened by the control board, and simultaneously, the control board relieves vacuum in the discharging chamber by opening an air duct and operates the oil pump to carry the oil outward,
in which if all of the oil is carried from the discharging chamber, the control board stops the oil pump and closes the air duct and the solenoid valve of the carrying tube, according to a signal detected by the position sensor, and after the solenoid valve of the pressure adjusting tube is opened according to a signal from the control board, the control board opens the solenoid valve of the discharging valve, and
in which the above steps are repeated, and the oil is continuously injected from the injection nozzle, while purified oil is discharged and carried outwardly.

3. The apparatus for purifying the waste lubricant as claimed in claim 1, wherein a surface of the injection nozzle is formed with a plurality of fine injection holes to maximize a surface area of the waste lubricant to be injected.

4. The apparatus for purifying the waste lubricant as claimed in claim 1, wherein a porous plate is installed in the vaporizing chamber by passing dropped oil through the porous plate to increase a dwelling time of the waste lubricant and enlarge a surface area, thereby improving a vaporizing efficiency of the water contained in the waste lubricant.

5. The apparatus for purifying the waste lubricant as claimed in claim 1, wherein the vaporizing chamber comprises a heater at an upper end of the chamber for preventing vaporized water from being dropped into the vaporizing chamber.

6. The apparatus for purifying the waste lubricant as claimed in claim 1, wherein a trapping filter is installed between the electrostatic separator and the electrode.

7. A method for purifying a waste lubricant, by which water and particulate pollutant are eliminated from the waste lubricant, the method comprising the steps of:
operating a vacuum pump such that a vacuum pressure is transferred to the condensate water container, a condenser, and a vaporizing chamber so as to decompress the interior of the vaporizing chamber in a vacuum state; p1 injecting a heated waste lubricant into the interior of the vaporizing chamber by an injection nozzle installed to the vaporizing chamber by vacuum pressure, vaporizing the injected waste lubricant by a vacuum vaporizing temperature, condensing the vaporized water by passing the water through the condenser, and collecting the condensed water in a condensate water container;
discharging the waste lubricant into a discharging chamber when a predetermined amount of the waste lubricant is stored in the vaporizing chamber or discharging the waste lubricant using discharging means when a predetermined amount of the waste lubricant is stored in the discharging chamber, with the waste lubricant being injected from the injection nozzle;
applying high voltage to an electrostatic separator consisting of a pair of discharge electrodes and a trapping filter to eliminate the particulate pollutant contained in the waste pollutant carried by an oil pump, and electrically charging the particulate pollutant by corona discharge generated between the pair of electrodes, the electrodes applied with the high voltage of polarity opposite to that of the charged particulate pollutant, so as to eliminate the particulate pollutant by an electrostatic force of the electric field; and
collecting the waste lubricant, from which the particulate pollutant is eliminated, into an oil storing container.

8. The method for purifying the waste lubricant as claimed in claim 7, wherein the discharging means comprises a pair of upper and lower position sensors spaced apart from each other at upper and lower portions of the vaporizing chamber and the discharging chamber respectively, and a control board for receiving a signal detected by the respective position sensors and selectively opening/closing solenoid valves,
in which the solenoid valves are opened to open a discharging tube and a pressure adjusting tube, which are connected between the vaporizing chamber and the discharging chamber, thereby discharging the oil from the vaporizing chamber to the discharging chamber,
in which if the discharging chamber is filled with a predetermined amount of the oil, the control board controls to close the solenoid valve of the discharging tube and the pressure adjusting tube, according to a signal detected by the position sensor,
in which the solenoid valve of a carrying tube is opened by the control board, and simultaneously, the control board relieves vacuum in the discharging chamber by opening an air duct and operates the oil pump to carry the oil outward,
in which if all of the oil is carried from the discharging chamber, the control board stops the oil pump and closes the air duct and the solenoid valve of the carrying tube, according to a signal detected by the position sensor, and after the solenoid valve of the pressure adjusting tube is opened according to a signal from the control board, the control board opens the solenoid valve of the discharging valve, and
in which the above steps are repeated, and the oil is continuously injected from the injection nozzle, while purified oil is discharged and carried outwardly.
